(19) United States
(12) Patent Application Publication
(10) Pub. No.: US 2006/0243710 A1
(43) Pub. Date: Nov. 2, 2006

(54) Dicing device

(75) Inventors: Masayuki Azuma, Tokyo (JP); Yasuyuki Sakaya, Tokyo (JP)

Correspondence Address: NIXON PEABODY, LLP, 401 9TH STREET, NW, SUITE 900, WASHINGTON, DC, 20004-2128, US

(73) Assignee: TOKYO SEIMITSU CO., LTD., Tokyo (JP)

(21) Appl. No.: 10/555,452

(22) PCT Filed: May 17, 2004
(86) PCT No.: PCT/JP04/06977

§ 371 Date: Nov. 3, 2005

(30) Foreign Application Priority Data
May 22, 2003 (JP) 2003-144596

(51) Int. Cl. B23K 26/38; B23K 26/03

(52) U.S. Cl. 219/121.67; 219/121.83

(57) ABSTRACT

There is provided a dicing apparatus comprising: a dicing section; an expanding section expanding spaces between individual chips which are diced by expanding a dicing sheet; and an inspection device confirming a diced and expanded state of a wafer. Thereby, the processing from the start of the dicing process to the end of the expanding process can be performed in a short period of time, and the dicing processing of subsequent wafer can be performed while the state of the diced wafer is confirmed.

### TECHNICAL FIELD

The present invention relates to a dicing apparatus dividing a wafer of semiconductor devices, electronic components and the like into individual chips, and more particularly to a dicing apparatus dividing a wafer stuck to a dicing sheet into individual chips.

### BACKGROUND ART

Conventionally, in order to divide a wafer, on the surface of which semiconductor devices, electronic components and the like are formed, into separate chips, there has been used a dicing apparatus which forms grinding grooves in the wafer by a thin grinding stone referred to as a dicing blade and cuts the wafer. The dicing blade is formed by making fine diamond abrasive grains electrodeposited by use of nickel, and the dicing blade having an extremely thin thickness of about 30 μm is used.

In the dicing apparatus, the dicing blade is rotated at a high speed of 30,000 to 60,000 rpm to form cuts in the wafer, so that the wafer is completely cut (full cutting) or incompletely cut (half cutting or semi-full cutting). The full cutting is a method for cutting the wafer stuck to the dicing sheet by forming cuts up to the extent of 10 μm in the dicing sheet, the half cutting is a method for forming cuts up to the extent of one half of the thickness in the wafer, and the semi-full cutting is a method for forming grinding grooves in the wafer by leaving a thickness of about 10 μm in the wafer.

However, when grinding work is performed by the dicing blade, since the wafer is a highly brittle material, the grinding work has to be a brittle mode and chipping is generated on the front surface and the rear surface of the wafer. This chipping causes the performance of divided chips to be degraded. In particular, the chipping generated on the rear surface makes a crack proceed into the inside of the chip, which is a troublesome problem.

Instead of cutting by use of the conventional dicing blade, as a method to solve the chipping problem in the dicing process, there has been proposed a laser machining apparatus in which laser light with a condensing point arranged inside the wafer is made incident so as to form a reformed region by multi-photon absorption inside the wafer, and in which the wafer is divided into individual chips by using the reformed region as a reference point (see for example, Japanese Patent Laid-Open No. 2002-192367, Japanese Patent Laid-Open No. 2002-192368, Japanese Patent Laid-Open No. 2002-192369, Japanese Patent Laid-Open No. 2002-192370, Japanese Patent Laid-Open No. 2002-192371, and Japanese Patent Laid-Open No. 2002-205180).

After the dicing process, the wafer is conveyed to a die bonding apparatus, in which an expanding processing for expanding the dicing sheet to increase spaces between individual chips is performed, and then, the individual chips are picked up and die-bonded to a base material.

However, the dicing apparatus using the conventional dicing blade forms dividing grooves in the wafer by use of an extremely thin dicing blade with a thickness of about 30 μm. On the other hand, in the laser machining apparatus proposed by the above described patent gazette documents, the wafer is divided into individual chips by cutting processing based on the cleaving effect along the crystal face of the wafer occurring from the reformed region formed in the wafer as a reference point. As a result, in both of the apparatuses, spaces between individual chips are made to be extremely narrow.

For this reason, when a diced wafer is conveyed from the dicing apparatus or the laser machining apparatus to the die bonding apparatus, the wafer stuck to the dicing sheet is deflected, so that edges of the chips contact with each other and thereby the chipping is generated at the edge of the chips. Further, after the dicing process, the wafer is conveyed to the die bonding apparatus to be subjected to the expanding process, as a result of which it takes time to perform the processing from the dicing process to the expanding process.

Further, in the die bonding apparatus, when the dicing sheet is expanded to increase spaces between the chips and the wafer is divided into individual chips by using the reformed region as the reference point, the chips are picked up without checking whether the spaces between the chips has been sufficiently increased in order to prevent a hindrance to the pickup operation of the chips, whether a defective chip having the chipping at its edge exists, and the like.

For this reason, there is a problem that when the operations for expanding the dicing sheet and for dividing the wafer are not properly performed, even defective chips are die-bonded to the base material and chips are damaged by the pickup failure of the chips.

In the prior art, after the dicing processing and the expanding processing are performed, the state of the wafer is confirmed, and such processes are repeated for each wafer, as a result of which there is a problem that it takes much time to process a number of wafers.

The present invention has been made in view of the above described circumstances. An object of the present invention is to provide a dicing apparatus capable of performing the processing from the start of the dicing process to the end of the expanding process in a short period of time, and of preventing defective chips from being produced.

### DISCLOSURE OF THE INVENTION

In order to achieve the above described object, according to the present invention, there is provided a dicing apparatus dicing a wafer stuck to a dicing sheet, the dicing apparatus comprising: a dicing section dicing the wafer and dividing the wafer into individual chips; an expanding section expanding the dicing sheet and increasing spaces between the individual chips; and an inspection device confirming the state of the wafer.

In the present invention, the inspection device may be arranged to be provided for the expanding section. Further, the inspection device may be arranged to confirm the expanded state of the spaces between the chips.

Further, in the present invention, the dicing section may be arranged to be a laser dicing section which makes laser light incident through the surface of the wafer so as to make a reformed region formed inside the wafer.

Further, in the present invention, the inspection device may be arranged to confirm the forming state of the reformed region formed inside the wafer by the laser dicing section.

Further, in the present invention, the inspection device may be arranged to confirm the forming state of the reformed region formed inside the wafer by the laser dicing section, and to confirm the expanded state of the spaces between the chips.

In the dicing apparatus according to the present invention, since the expanding section is provided, the conveyance distance of the diced wafer is slight, so that it is possible to prevent the chipping from being generated at the edge of the chips during the conveyance. Further, the expanding processing can be performed immediately after the dicing processing, so that it is possible to perform the processing from the start of the dicing process to the end of the expanding process in a short period of time.

Further, in the dicing apparatus according to the present invention, since the inspection device confirming the state of the wafer is provided, it is possible to confirm the expanded state after the expanding processing, and also to confirm the forming state of the reformed region formed inside the wafer by the laser before the expanding processing. This makes it possible to prevent defective chips from being die-bonded, and chips from being damaged by the pickup failure of the chips.

Further, according to the present invention, since the inspection device confirming the state of the wafer is provided, it is possible to perform dicing processing of a subsequent wafer, while the diced state or the expanded state of the diced wafer is confirmed. That is, the processing for dicing the wafer can be performed in parallel with the processing for confirming the diced state or the expanded state, as a result of which a number of wafers can be processed in a short period of time.

### BRIEF DESCRIPTION OF THE DRAWINGS

FIG. 1 is a schematic representation of a dicing apparatus according to the present invention;

FIG. 2 is a figure showing conceptual configuration explaining a laser dicing section;

FIG. 3 is a figure showing conceptual configuration explaining an expanding section;

FIG. 4 is a perspective view showing a wafer mounted to a frame; and

FIG. 5(a) and FIG. 5(b) are conceptual drawings explaining a reformed region formed in the vicinity of the condensing point inside the wafer.

### BEST MODE FOR CARRYING OUT THE INVENTION

In the following, preferred embodiments of a dicing apparatus according to the present invention will be described in detail with reference to accompanying drawings. Note that in each figure, the same reference numerals or the same reference characters are provided for the same components.

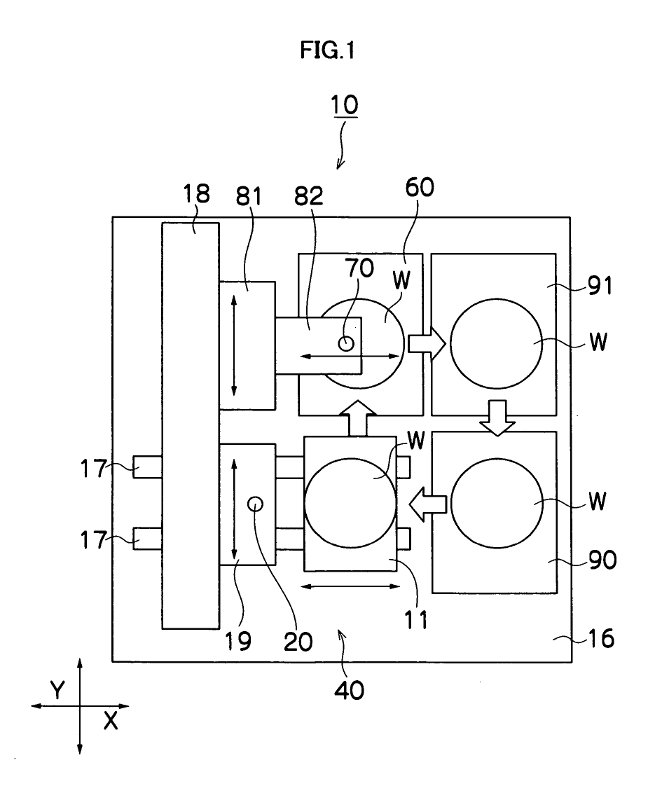

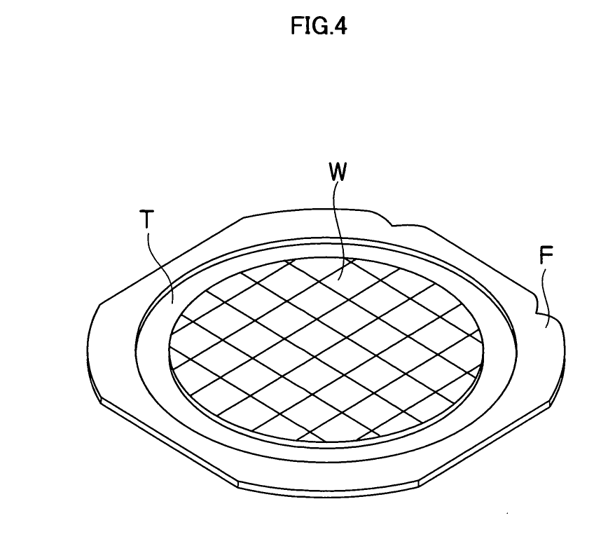

FIG. 1 is a top view showing a schematic configuration of a dicing apparatus according to the present invention. In the dicing apparatus 10, as shown in FIG. 4, a wafer which is stuck to a dicing sheet T having a adhesive material on one of its surfaces, is conveyed in the dicing apparatus 10 in a state integrated with a frame F via the dicing sheet T, and conveyed within the dicing apparatus 10.

As shown in FIG. 1, the dicing apparatus 10 comprises a cassette storage section 90, an elevator 91, a laser dicing section 40 as a dicing section, an expanding section 60, and a conveyance device of the wafer W (not shown), a control section 50 (as will be described below), and a television monitor 36 (as will be described below).

In the cassette storage section 90, a cassette containing a number of wafers W in a state integrated with the frame F via the dicing sheet T is stored. The elevator 91 is provided with a frame damper (not shown) which is moved up and down, and which is also forwards and backwards. The frame damper clamps the frame F to take out the wafer W from the cassette, or to make the diced wafer W stored in the cassette.

The laser dicing section 40 makes laser light incident through the surface of the wafer W and a reformed region formed inside the wafer W, so that the wafer W is diced into individual chips. In the expanding section 60, the dicing sheet T stuck with the diced wafer W is expanded so that spaces between the individual chips are increased.

The conveyance device conveys the wafer W to each part of the dicing apparatus 10. The control section 50 comprises a CPU, a memory, an input/output circuit section, various drive circuit sections and the like, which are connected with each other by a bus line, and controls the operation of each section of the dicing apparatus 10. The television monitor 36 displays a program setting screen and various observation screens.

On a main body base 16, X guide rails 17 arranged in the X direction in FIG. 1 are attached. Further, a gate-shaped Y guide rail 18 straddling the X guide rail 17 and extending in the Y direction in FIG. 1 over the X guide rail 17 is attached.

The X guide rail 17 guides an XZ θ table 11 of the laser dicing section 40, and the XZ θ table 11 is moved in the X direction by a driving device (not shown), for which a known driving device such as a linear motor is used.

The Y guide rail 18 guides a laser optical section 20 of the laser dicing section 40, a Y table 19 to which an observation optical section 30 (as will be described below) is attached, and also guides a Y moving table 81 of the expanding section 60. The Y table 19 and the Y moving table 81 are precisely index-fed in the Y direction by a driving device (not shown), such as a linear motor.

The Y moving table 81 of the expanding section 60 is integrated with an X moving table 82 moving in the X direction, to which an inspection device 70 is attached. Thereby, the inspection device 70 is moved in the X direction and is precisely index-fed in the Y direction.

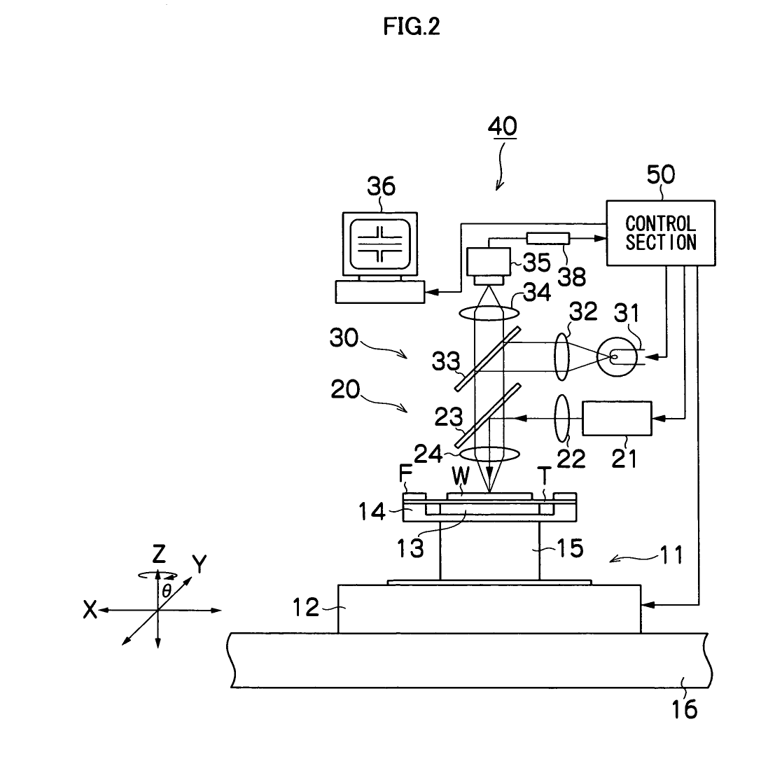

FIG. 2 is a figure showing conceptual configuration of the laser dicing section 40 in detail. The laser dicing section 40 comprises the XZ θ table 11, the laser optical section 20, the observation optical section 30 and the like.

The XZ θ table 11 consists of an X table 12 which is guided by the X guide rail 17 and moved in the X direction, and a Z θ table 15 which is attached on the X table 12 and driven in the Z direction and the θ direction in FIG. 2. A suction stage 13 for holding the wafer W via the dicing sheet T, and a receiving base 14 for holding the frame F are attached to the Z θ table 15. The wafer W is precisely moved by the XZ θ table 11 in the XZ θ direction in FIG. 2.

The laser optical section 20 which is arranged to be attached to the Y table 19 and precisely index-fed in the Y direction, comprises a laser oscillator 21, a collimator lens 22, a half mirror 23, a condensing lens 24 and the like.

The observation optical section 30 comprises an observation light source 31, a collimator lens 32, a half mirror 33, a condensing lens 34, a CCD camera 35 as an observation device, the television monitor 36 and the like.

In the laser optical section 20, laser light emitted from the laser oscillator 21 is condensed inside the wafer W through the optical system including the collimator lens 22, the half mirror 23, the condensing lens 24 and the like. Here, the laser light having transmissivity to the dicing tape in a condition of the peak power density not smaller than 1×10⁸ (W/cm²) at the condensing point and the pulse width up to 1 μs, is used. The position of the condensing point in the Z direction is adjusted by the fine movement of the XZ θ table 11 in the Z direction.

In the observation optical section 30, the illumination light emitted from the observation light source 31 is irradiated to the surface of the wafer W through the optical system including the collimator lens 32, the half mirror 33, the condensing lens 24 and the like. The reflected light from the surface of the wafer W is incident on the CCD camera 35 as an observation device through the condensing lens 24, the half mirrors 23, 33 and the condensing lens 34, so that the-surface image of the wafer W is picked up.

The picked-up image data, which is inputted to an image processing section 38, is used for aligning the wafer W and also displayed on the television monitor 36 via the control section 50.

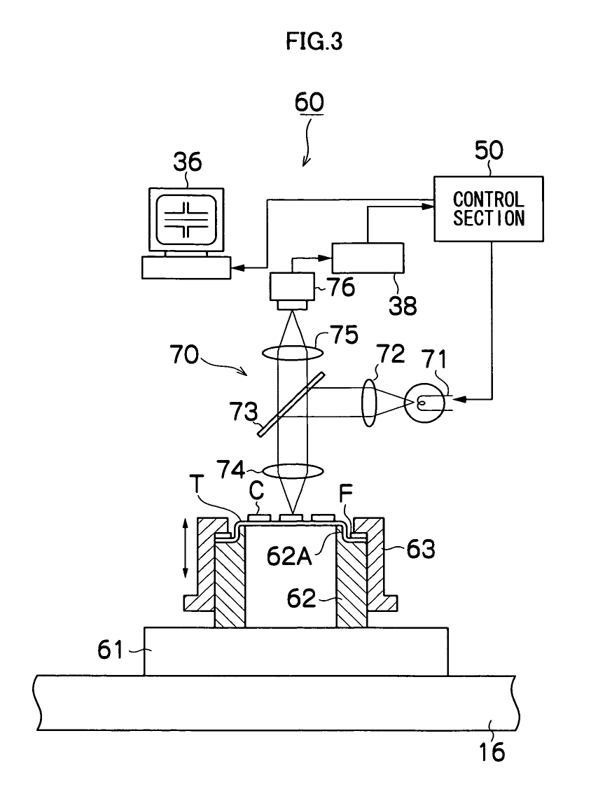

FIG. 3 is a figure showing conceptual configuration explaining the expanding section 60. The expanding section 60 is provided for increasing spaces between mutually adjoining individual chips C of the wafer W which is diced while being stuck to the dicing sheet T, and performs expanding processing by expanding the dicing sheet T from the center part to the outside direction.

The expanding section 60 comprises a base 61 fixed to the main body base 16, a receiving ring 62 attached to the base 61, a press ring 63 which is in slidable engagement with the outer circumference of the receiving ring 62 and is vertically movably supported so as to press downward the frame F stuck with the dicing sheet T, and a driving device (not shown) such as an air cylinder, for vertically moving the press ring 63.

The inspection device 70 for checking the state of the wafer W is provided for the expanding section 60. In the inspection device 70, the illumination light emitted from a light source 71 is irradiated to the wafer W through a collimator lens 72, a half mirror 73 and a condensing lens 74 and the like.

The reflected light of the irradiated light is incident on a CCD camera 76 as the observation device through the condensing lens 74, the half mirror 73, and a condensing lens 75, so that an observation image is displayed on the television monitor 36 via the control section 50. The picked-up image data is inputted to the image processing section 38, so that the state of the wafer W is confirmed and is also displayed on the television monitor 36 via the control section 50.

This inspection device 70 is moved in the X direction and the Y direction over the wafer W by the X moving table 82 and the Y moving table 81 arranged above the expanding section 60.

The infrared light is used for the light source 71. When the forming state of the reformed region formed inside the wafer W by the laser light is confirmed before the expanding processing, an image is picked up by focusing the laser light inside the wafer by a high magnification. Further, when the expanded state is confirmed after the expanding processing, an image is picked up by focusing the laser light on the surface of the wafer by a low magnification. These image data are subjected to data processing in the image processing section 38, and thereafter, sent to the control section 50 so as to enable the state of the wafer W to be analyzed.

Next, the effect of the dicing apparatus 10 constituted as described above is explained. The wafer W mounted to the ring-shaped frame F via the dicing seat T is pulled out from the cassette stored in the cassette storage section by the damper provided for the elevator 91. The wafer W is then conveyed by the conveyance device onto the XZ θ table 11 of the laser dicing section 40, and is sucked and held by the suction stage 13.

The circuit pattern formed on the surface of the wafer held by the suction stage 13, is imaged by the CCD camera 35, and the wafer is aligned in the θ direction and positioned in the XY direction by the alignment device provided in the image processing section 38 and the control section 50.

When the aligning processing is completed, the XZ θ table 11 is moved in the X direction, and the laser light is made incident along the dicing street of the wafer W. The condensing point of the laser light incident through the surface of the wafer W is set to the inside of the wafer W in its thickness direction. Thus, the energy of the laser light transmitted through the surface of the wafer is condensed at the condensing point inside the wafer, so that a reformed region by multi-photon absorption, such as a crack region, a melting region and a refractive index changing region, is formed in the vicinity of the condensing point inside the wafer W. As a result, the balance of intermolecular forces is broken, thereby enabling the wafer to be divided naturally or by applying slight external force.

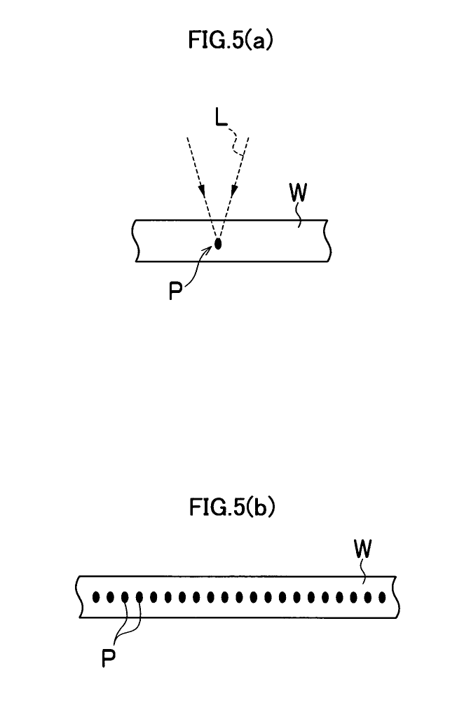

FIG. 5 is a conceptual drawing explaining a reformed region formed in the vicinity of the condensing point inside the wafer. FIG. 5(a) shows a state where a reformed region P is formed at the condensing point by the laser light L incident to the inside of the wafer W, and FIG. 5(b) shows a state where discontinuous reformed regions P are formed side by side by horizontally moving the wafer W, while the pulse-like laser light is irradiated on the wafer W. In this state, the wafer W is divided from the reformed region P as a starting point naturally or by applying a slight external slight force. In this case, the wafer W is easily divided into chips, without the chipping being generated on the front surface and the rear surface of the wafer W.

When the processing for forming the reformed region P for one line is completed, the Y table attached to the laser optical section 20 is moved by one index in the Y direction, and the laser light is made incident along the subsequent dicing street, so as to form the reformed region P inside the wafer.

When the reformed region is formed for all dicing streets in one direction, the Z θ table 15 is rotated by 90°, and the reformed region is also formed for all dicing streets in the direction perpendicular to the dicing streets for which the reformed region has been formed.

The wafer W to which the laser dicing processing for forming the reformed regions P inside the wafer has been performed for all dicing streets, is conveyed by the conveyance device to the expanding section 60, and is set on the receiving ring 62 provided for the expanding section 60.

Here, the forming state of the reformed region inside the wafer is confirmed by the inspection device 70. The confirming processing is performed by picking up images inside the wafer, while scanning the infrared light from the light source 71 by the X moving table 82 and the Y moving table 81. The forming state of the reformed regions can be confirmed by use of a screen displayed on the television monitor 36, and the quality of the forming state of the reformed regions is automatically determined by a reformed region forming state determining section (not shown) provided on the control section 50. Further, the determination result is fed back to the irradiation condition of the laser light L.

When the forming state of the reformed regions is confirmed, the press ring 63 is then lowered so as to push down the frame F, as a result of which the dicing sheet T is expanded. At this time, since the outer perimeter 62A on the upper surface of the receiving ring 62 is beveled in a circular arc shape, the dicing sheet T is smoothly expanded so that spaces between individual chips C are increased.

Then, the surface of the plurality of chips C is imaged by the inspection device 70, and thereby the expanded state is inspected. The inspection is performed for the whole surface of the wafer W by scanning the inspection device 70 by use of the X moving table 82 and the Y moving table 81. The picked-up images are processed by the image processing section 38 and thereafter the image data are sent to the control section 50.

In the control section 50, the expanded state is displayed on the television monitor 36, and whether spaces between individual chips has been expanded by a predetermined amount or not is automatically determined. The determination result is also fed back so that the lowering amount of the press ring 63 is controlled. Further, the size of chipping generated on the periphery of the chips C and the like is checked.

Next, the processing of loosened parts of the expanded dicing sheet T is performed, and the individual chips C are conveyed from the expanding section 60 by the conveyance device by each frame F while the individual chips C being stuck to the dicing sheet T. Next, the wafer W is returned to the original position in the cassette by the elevator 91.

As described above, each wafer W stored in the cassette is successively diced in the laser dicing section 40. Then, in the expanding section 60, the forming state of the reformed region formed inside the wafer W is confirmed, the dicing sheet is expanded, and further the expanded state is confirmed. For this reason, spaces between the individual chips C on the dicing sheet T are stably increased by the predetermined amount.

Further, when the laser dicing processing for one wafer W is completed and the wafer W is conveyed from the laser dicing section 40 to the expanding section 60, a next wafer W is also conveyed to the laser dicing section 40. Accordingly, the forming state of the reformed regions and the expanded state are confirmed while the next wafer W is subjected to the laser dicing processing, so that the sate of the wafer W can be confirmed without lowering the processing speed of the dicing apparatus 10.

Note that there is used as the dicing section in the above describe embodiment, a laser dicing section 40 forming a reformed region inside the wafer W by using a laser light, but the present invention is not limited to the case, a dicing section using a dicing blade may also be used. In this case, the inspection device 70 need not confirm the forming state of the reformed regions, and hence, the light source 71 need not be a infrared light source, but may be a white light source.

### INDUSTRIAL APPLICABILITY

As described above, in the dicing apparatus according to the present invention, it is possible to perform the expanding processing by the expanding section, immediately after the dicing processing. As a result, the processing from the start of the dicing process to the end of expanding process can be performed in a short period of time. Further, it is possible to eliminate the problem that the diced individual chips contact with each other during the conveyance of the diced wafer and thereby the chipping is generated at the edge of the chips.

Further, according to the present invention, it is possible to confirm the expanded state after the expanding process. As a result, it is possible to check whether spaces between the chips are properly increased, whether a defective chip having the chipping at its edge exists, and the like. Further, it is possible to confirm the forming state of the reformed region formed inside the wafer by the laser before the wafer is expanded. As a result, the forming state of the reformed region can be fed back to the laser irradiation condition, so that the reformed region can be formed to be in a suitable state and the wafer can be preferably divided. For this reason, it is possible to prevent a defective chip from being die-bonded. It is also possible to avoid damage to the chip due to the pick-up failure of the chip, and to thereby prevent a defective chip from being produced.

Further, according to the present invention, the inspection device for confirming the state of the wafer is provided for the expanding section, so that the dicing processing of a subsequent wafer can be performed while the dicing state of the diced wafer or the expanded state of the diced wafer is confirmed. That is, the dicing processing of the wafer and the processing for confirming the dicing state or the expanded state can be performed in parallel with each other, as a result of which the operation speed of the dicing apparatus can be increased.

1. A dicing apparatus dicing a wafer stuck to a dicing sheet, said dicing apparatus comprising:
a dicing section dicing and dividing said wafer into individual chips;
an expanding section expanding said dicing sheet and increasing spaces between said individual chips; and
an inspection device confirming a state of said wafer,
wherein said dicing section, said expanding section, and said inspection device are arranged in an integral structure, and
wherein processing from the start of dicing process to the end of expanding process are performed in the integral structure.

2. The dicing apparatus according to claim 1, wherein said inspection device is provided for said expanding section and confirms the expanded state of the spaces between said individual chips.

3. The dicing apparatus according to claim 1, wherein said dicing section is a laser dicing section dicing said wafer by making laser light incident from the surface of said wafer and by forming a reformed region inside said wafer.

4. The dicing apparatus according to claim 1, wherein said dicing section is a laser dicing section dicing said wafer by making laser light incident from the surface of said wafer and by forming a reformed region inside said wafer, and wherein said inspection device is provided for said expanding section and confirms the expanded state of the spaces between said individual chips.

5. The dicing apparatus according to claim 1, wherein said dicing section is a laser dicing section dicing said wafer by making laser light incident from the surface of said wafer and by forming a reformed region inside said wafer, and wherein said inspection device confirms a forming state of a reformed region formed inside said wafer by said laser dicing section.

6. The dicing apparatus according to claim 1, wherein said dicing section is a laser dicing section dicing said wafer by making laser light incident from the surface of said wafer and by forming a reformed region inside said wafer, and wherein said inspection device is provided for said expanding section, confirms the expanded sate of the spaces between said individual chips, and confirms a forming state of a reformed region formed inside said wafer by said laser dicing section.
